(19) United States
(12) Patent Application Publication
(10) Pub. No.: US 2006/0253971 A1
(43) Pub. Date: Nov. 16, 2006

(54) Double seal gasket

(75) Inventors: Raymundo Colin, Simi Valley, CA (US); Francisco Hinojosa JR., Santa Paula, CA (US); Darrell Schmidt, Simi Valley, CA (US)

Correspondence Address: KOPPEL, PATRICK & HEYBL, 555 ST. CHARLES DRIVE, SUITE 107, THOUSAND OAKS, CA, 91360, US

(73) Assignee: B&S PLASTICS, INC., dba WATERWAY PLASTICS, INC.

(21) Appl. No.: 11/345,146

(22) Filed: Jan. 31, 2006

Related U.S. Application Data
(60) Provisional application No. 60/648,997, filed on Jan. 31, 2005.

(51) Int. Cl. A61H 33/04

(52) U.S. Cl. 4/541.6

(57) ABSTRACT

A gasket for providing a watertight seal between a spa wall hole and spa component comprises a front extension at least partially covering the front surface around the spa wall hole. A rear extension at least partially covers the back surface around the spa wall hole. The spa component has a front portion and a back portion, with the front extension sandwiched between the front portion and the front surface to provide a watertight seal at the front surface at least partially around the hole. The rear extension is sandwiched between the back portion and the back surface of the hole to provide a watertight seal at the back surface at least partially around the hole. The gasket can also be arranged to provide a seal between the spa component and the inside surface of the spa wall hole.

### BACKGROUND OF THE INVENTION

1. Field of the Invention

This invention relates to gaskets, and particularly to gaskets for sealing components mounted in a spa.

2. Description of the Related Art

Various hydrotherapy jets have been developed for use in spas, hot tubs, pools and bath tubs that discharge a stream of water, which can be aerated through a variety of discharge nozzles. The designs provide different flow characteristics that result in different massage affects being experienced by the body. Such jets have been found to produce a pleasing massaging effect for many users, and have become quite popular. In the design of single or multi-user spas or tubs, it is common to use a variety of different jet nozzles to provide a variety of different massaging effects.

Typical hydrotherapy jets comprise a generally cylindrical jet body having a water inlet that receives a standard water supply tube from the spa plumbing. The body can also have an air inlet tube to allow air into the body in applications where an aerated stream of water is produced by the jet. The jet body typically has an external flange around its opening to the spa that is positioned on the spa's water contacting wall. The outside surface of the body adjacent to the flange has a threaded section for mating with the threads of a wall fitting. A gasket or other devices or compounds that provide a watertight seal are typically included on the wall fitting and/or flange to provide a seal between the spa wall and jet. The fitting is rotated on the body threads until the flange tightens against the spa wall. The jet is held securely in place with the spa wall sandwiched between the flange and the fitting.

Commercially available compounds such as silicones can be used to provide a watertight seal. The silicone is spread around the jet opening in the spa wall, most often on both sides of the opening. The flange is then placed against the spa wall with the silicone sandwiched between the flange and wall. The fitting is then turned onto the body threads until the silicone is sandwiched between the fitting and wall. The silicone is then allowed to cure to provide the watertight seal.

Silicones, however, are often very expensive and when used as described herein, there can be waste of the silicone that is forced out from underneath the flange and fittings when the jet is secured in place. Silicones can also be inconsistent in their quality from batch to batch, with lower quality silicones not providing the necessary sealing properties. Silicones made of certain complex combinations of compounds can break down or damage the jet or spa wall material over time.

Gaskets made of materials such as rubber or cured silicone can also be used, with the gaskets sized to fit around the spa opening, with a first gasket typically on the water contacting side of the spa wall and a second gasket on the fitting side. When the fitting is tightened on the jet body a watertight seal is provided by the first gasket being sandwiched between the flange and the spa wall and the second gasket being sandwiched between the fitting and spa wall.

Gaskets used in this way, however, must be held in place as the fitting is tightened on the jet body, which can be awkward and difficult. If the gaskets are not properly placed, a watertight seal may not be achieved. Adhesives such as glue or silicone can be used to hold the gaskets in place, but this can add to the cost of the gaskets and as described above, certain silicones (and glues) can damage the spa wall over time.

### SUMMARY OF THE INVENTION

In general terms, the present invention relates to an improved mechanism that provides a watertight seal between a spa component and a spa wall, with the mechanism being easier to use and providing a more reliable seal. It is understood, however, that the invention can be used in many applications beyond spas and spa components.

One embodiment of a gasket according to the present invention for providing a watertight seal between a hole and a body mounted within said hole, comprises a front extension at least partially covering a front surface around the hole. A rear extension at least partially covering a back surface of the hole, with the front and rear extensions connected by a base section. The body has a front portion and a back portion, with the front extension sandwiched between the front portion and the front surface to provide a watertight seal at that front surface at least partially around the hole. The rear extension is sandwiched between the back portion and the back surface to provide a watertight seal at the back surface at least partially around the hole.

One embodiment of a gasket for providing a watertight seal between a spa wall hole and spa component comprises a front extension at least partially covering the front surface around the spa wall hole. A rear extension at least partially covers the back surface around the spa wall hole. The spa component has a front portion and a back portion, with the front extension sandwiched between the front portion and the front surface to provide a watertight seal at the front surface at least partially around the hole. The rear extension is sandwiched between the back portion and the back surface of the hole to provide a watertight seal at the back surface at least partially around the hole.

One embodiment of a spa system according to the present invention comprises a spa shell that is capable of holding water. At least one spa component is mounted in a hole in the spa shell with a gasket, wherein the gasket comprises a front extension at least partially covering the front surface of said spa shell around the spa shell hole. A rear extension at least partially covering the back surface of said spa shell around the spa shell hole, the front and rear extensions connected by a base section. The spa component having a front portion and a back portion, with the front extension sandwiched between the front portion and the front surface of the spa shell around the hole to provide a watertight seal at the front surface at least partially around the hole. The rear extension is sandwiched between the back portion and the back surface of the spa shell around the hole to provide a watertight seal at the back surface at least partially around the hole.

These and other further features and advantages of the invention will be apparent to those skilled in the art from the following detailed description, taken together with the accompanying drawings, in which:

### BRIEF DESCRIPTION OF THE DRAWINGS

FIG. 1 is a perspective view of an embodiment of a gasket according to the present invention;

FIG. 2 is a plan view of the gasket shown in FIG. 1;

FIG. 3 is a sectional view of the gasket shown in FIG. 2, taken along section lines 3-3;

FIG. 4 is a sectional view of a spa component using one embodiment of a gasket according to the present invention;

FIG. 5 is a sectional view of another spa component using a gasket according to the present invention, before the component is affixed in place;

FIG. 6 shows is a sectional view of the spa component in FIG. 5, after the component is fixed in place; and

FIG. 7 is a perspective view of a spa/tub system having spa components using embodiments of double seal gaskets according to the present invention.

### DETAILED DESCRIPTION OF THE INVENTION

The present invention provides a gasket that can be used to provide a watertight seal between many different components, but is particularly adapted for providing a watertight seal between the spa wall and spa component. Gaskets according to the present invention are arranged to provide a seal on both sides of the spa wall, and in some embodiments, between the spa component and the inside surface of the hole. The gasket is preferably made of a sufficiently firm material that allows the gasket to be held within a hole in the spa wall and fit to the size of the hole. The gasket remains within the hole without the use of adhesives and without being held in place by hand. The gaskets according to the present invention can be made of many different flexible and waterproof materials, including but not limited to rubber, plastic or silicone, or a combination thereof. In other embodiments, the flexible and waterproof materials can be used in combination with ridged materials such as plastics and PVC.

The description of the embodiments below is in reference to spas and spa components, but it is understood that gaskets according to the present invention can be used in many other applications. One embodiment of a mechanism comprises a double seal gasket having a generally U-shaped cross section and mounted within a spa wall hole, with the wall within the U of the gasket. The front extension of the gasket is adjacent to the water contacting surface of the spa wall and a rear extension that is adjacent to the opposite spa wall surface. The front and rear extensions are sandwiched between portions of the spa component to provide a watertight seal between the spa component and the spa wall.

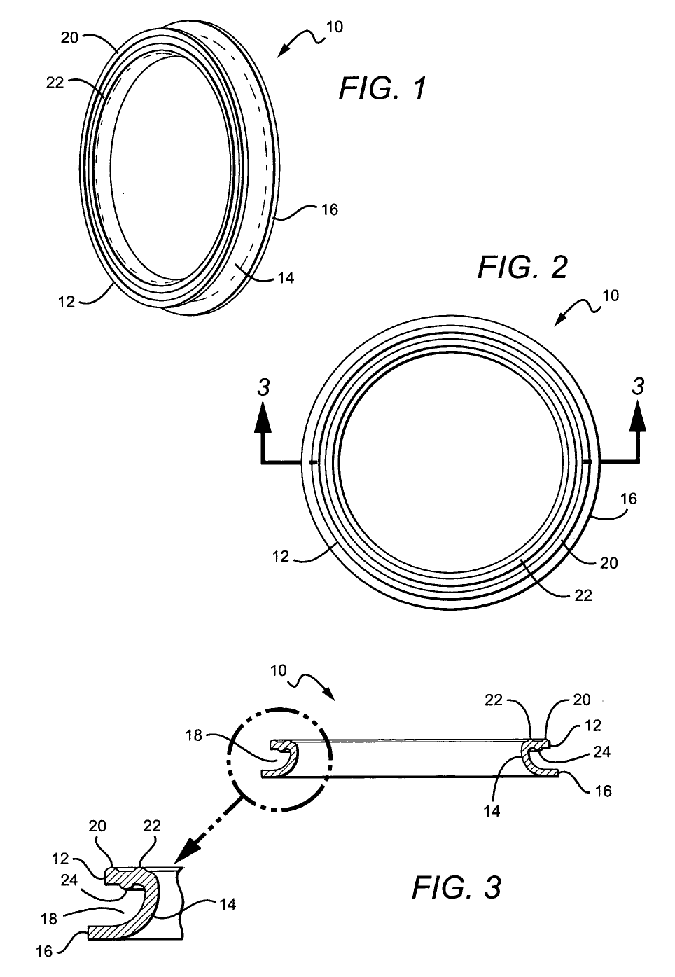

FIGS. 1-3 show one embodiment of a double seal gasket 10 according to the present invention that is shaped to fit inside an opening in a spa wall for a spa component. During the manufacturing of a typical spa, a hole is created in the spa wall having a size for the particular spa component. The hole can have many different shapes including but not limited to oval, square, rectangular, octagonal, with a typical spa hole being circular. A spa component is typically mounted within the spa hole and connected to the spa plumbing for operation as more fully described below. Spa components can have different shapes and sizes and can be mounted to a spa wall in many different locations. The gaskets according to the present invention can be sized accordingly to fit the different sized and shaped spa wall holes.

The gasket 10 is circular to fit within a circular spa wall hole and as best shown in FIG. 3, has a generally U-shaped cross-section that opens outward and away from the gasket's center. Other embodiments of the gasket 10 can have other cross-sections according to the present invention, such as generally V-shaped. The gasket 10 comprises a front extension 12 and a rear extension 16, with a space 18 between the front and back extensions 12 and 16. The space 18 is sized so that the spa wall (not shown) can fit between the front and rear extensions 12, 16. The front and rear extensions are joined along at least part of their lengths, and as shown are joined along their entire length by a base section 14. It is understood that the gasket can also have sections where the front and back extensions are not joined. In one such embodiment, the base section 14 can have openings in those areas where the front and back sections are not joined. The gasket 10 can have different diameters and can fit in the spa hole in different ways. In one embodiment, preferably the gasket 10 has a diameter such that the base section 14 rests against the inside surface of the spa hole when the gasket 10 is installed.

The gasket 10 can have different sealing features that allow it to more effectively create a watertight seal, with the features typically included on the front and back extensions 12, 16. As shown, the forward surface of the front extension 12 has sealing features in the form of first and second ridges 20, 22 that run around the front extension. As shown, the ridges have a uniform size and width and are uninterrupted around the gasket, as best shown in FIG. 1. It is understood, however, that the ridges can have different sizes and shapes along their lengths and can have interruptions. The inside surface of the front extension 12 has a third ridge 24 that also has a uniform size and uninterrupted around the front flange 12, although like first and second ridges 20, 22, the third ridge 24 can be different sizes along its length and can have interruptions. It is understood that the front extension 12 can have different numbers of ridges, if any, on its surfaces, and that the back extension 16 can also have ridges.

As more fully described below, when the spa component is installed in the spa wall hole, the front extension 12 is sandwiched between a portion of the spa component and the ridges are compressed, which generally provides a more reliable watertight seal between the component and spa wall. Similarly, the rear extension is also sandwiched between the spa component and the spa wall to provide a watertight seal.

In use, the gasket 10 is compressed by hand so that it can be fitted within a spa wall hole. Once within the hole, the compression force is released and the gasket 10 is allowed to expand within the hole, with the spa wall between the front and back extensions 12, 16. The outward force of the gasket 10 and the front and back extensions holds the gasket within the spa hole without adhesives and without being held in place by hand. It is understood, however, that the gasket 10 can also be used with glues or other adhesives, such as silicone.

After the gasket 10 is in place within the spa wall, the spa component can be mounted within the spa wall as described below, with the gasket providing a watertight seal between the spa component and spa wall. In a preferred embodiment, the spa hole, gasket and spa component are sized so that the spa component can be inserted in the spa hole with the gasket in place such that the pressure and friction between the spa component and gasket do not force the gasket out of the hole as the component is being inserted.

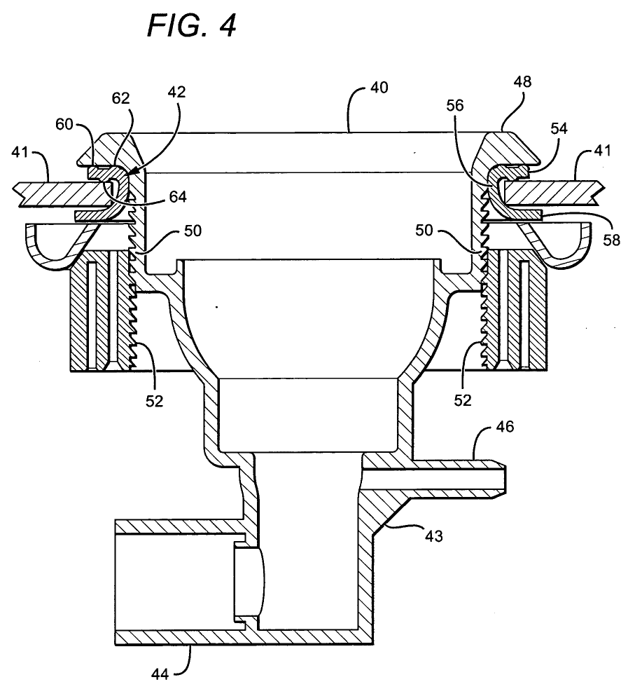

FIG. 4 shows one embodiment of a spa component 40 that can be installed on a spa wall 41 with the double seal gasket 42 according to the present invention, although it is understood that the gasket can be used with other components. The spa component 40 comprises a spa jet, and for ease of understanding the jet is shown without its internal components. The jet and its components are preferably formed from a water impervious plastic such as ABS, PVC or CPVC. It is particularly adapted to be positioned below the water level on the spa wall 41, with the majority of the jet positioned behind the water contacting surface of the spa wall.

The jet 40 includes a jet body 43 having a water inlet 44 that receives a standard water supply tube. The body 43 can also have an air inlet tube 46 to allow air into the body 43 in applications where aerated water is desired. The jet body 43 has an external flange 48 that is positioned on the water contacting surface of the spa wall. The outside surface of the body 43, adjacent to the flange 48, has a threaded section 50 for mating with the threads of a wall fitting 52. The fitting 52 is rotated until the flange 48 tightens against the spa wall 41 on the water contacting side of the spa hole, and the fitting 52 tightens against the spa wall 41 on the other side. The jet 40 is held securely in place in the spa, with the spa wall 41 sandwiched between the flange 48 and the fitting 52.

Similar to the gasket 10 in FIGS. 1-3, the gasket 42 has a U-shaped cross-section and comprises a front extension 54, a base section 56 and a rear extension 58. The front extension 54 is adjacent to the water contacting surface of the spa wall 41 and the rear extension is adjacent to the opposite surface of the spa wall. The gasket 42 has a diameter sized such that the inside surface spa wall 41 is adjacent to the outside surface of the base section 56 and preferably with no space between the two.

The forward surface of the front extension also includes first and second continuous ridges 60, 62 and the back surface has a third continuous ridge 64, as described above. As the wall fitting 52 is turned on to the threaded section of the jet body 43 the external flange 48 closes on the first and second ridges 60, 62 and the third ridge 64 is forced against the spa wall 41. As the wall fitting 52 is fully turned on the threads 50 the front extension 54 and the ridges 60, 62 and 64 are compressed between the flange 48 and spa wall 41 with the third ridge compressed toward the area between the first and second ridges 60, 62. This arrangement provides an effective watertight seal.

The rear extension 58 is arranged between the wall fitting 52 and the inside surface of the spa wall 41. As the wall fitting 52 turns on the threaded section 50 the rear extension is sandwiched between the wall fitting 52 and the inside surface of the spa wall 41 to provide a watertight seal.

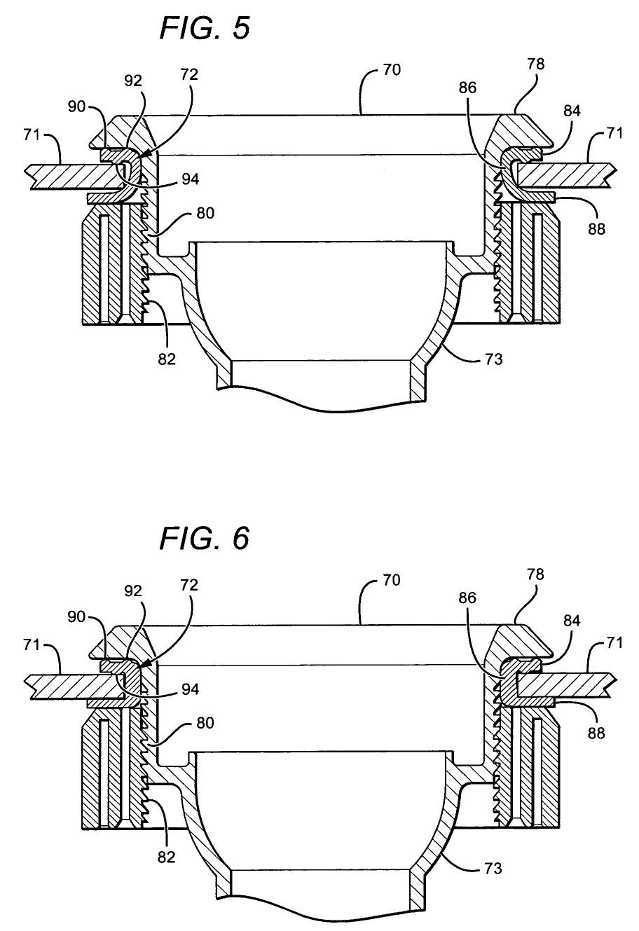

FIGS. 5 and 6 show another embodiment of a spa component 70 that can be installed on a spa wall 71 with a gasket 72 according to the present invention. The spa component 70 is similar to the spa component 40 shown in FIG. 4 and described above. It generally comprises a spa jet and its components are preferably formed from a water impervious plastic such as ABS, PVC or CPVC. It is particularly adapted to be positioned below the water level on the spa wall 71, with the majority of the jet positioned behind the water contacting surface of the spa wall.

The jet 70 includes a jet body 73 having a water inlet and air inlet tube (not shown). The jet body 73 has an external flange 78 that is positioned on the water contacting surface of the spa wall. The outside surface of the body 73 has a threaded section 80 for mating with the threads of a wall fitting 82 that is rotated until the flange 78 tightens against the spa wall 71 on the water contacting side of the spa hole, and the fitting 82 tightens against the spa wall 71 on the other side

The gasket 72 has a U-shaped cross-section and comprises a front extension 84, a base section 86 and a rear extension 88. The forward surface of the front extension also includes first and second ridges 90, 92 and the back surface has a third ridge 94, as described above. Referring now to FIG. 5, as the wall fitting 82 is turned on to the threaded section of the jet body 73 the external flange 78 closes on the first and second ridges 90, 92 and the third ridge 94 is forced against the spa wall 41. In this embodiment, the gasket 72 is made of a material that is compressible, with a suitable material being rubber or silicone. The spa component 70 is shown prior to the wall fitting 82 being fully turned onto the jet body 73.

Referring now to FIG. 6, as the wall fitting 82 is fully turned on the jet body, the front extension 84 and the ridges 90, 92 and 94 are compressed between the flange 78 and spa wall 71. The rear extension 78 is arranged between the wall fitting 82 and the inside surface of the spa wall 71. As the wall fitting 82 turns on the jet body 73 the rear extension 78 is compressed and sandwiched between the wall fitting 82 and the inside surface of the spa wall 71 to provide a watertight seal. The compression on the front and rear extensions 84, 88 also cause the base section 86 to bulge, which in turn cases the base section 86 to provide a watertight seal between the jet body 73, and the inside edge of the hole in the spa wall 71. In this embodiment, the gasket provides a seal between the spa component and the hole in the spa wall 71, at three surfaces; the water contacting surface of the wall 71 around the hole, the opposite surface around the hole 71, and the edge of the hole 71 facing the jet body 73.

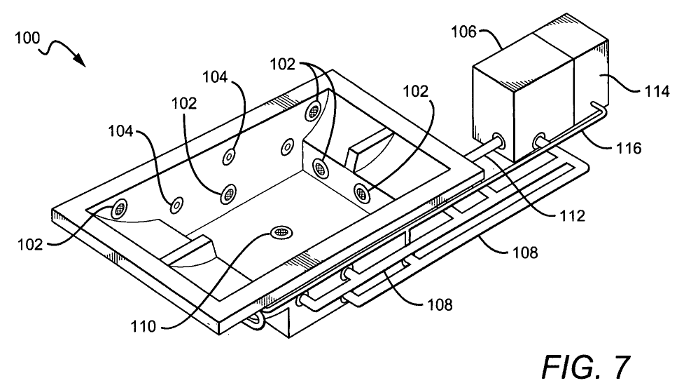

As shown in FIG. 7, multiple jets (or other spa components) can be installed in a spa 100. Some or all of the jets can be installed using gaskets according to the present invention, with the jets 102 in spa 100 as shown each being arranged with such a gasket. The remaining jets can be any other desired type, such as a variety of prior jets 104 using conventional gaskets or sealants. Both types of jets are connected to a water pump 106, used to circulate the water throughout the spa system, by a series of water conduits 108. Water from spa 100 is provided to pump 106 through the drain 110, which is connected through return water conduit 102 to pump 106. Water from pump 106 is provided back to spa 100 by conduits 108, where it flows into jets 102 and 104, as the case may be, and in turn into spa 100, completing the loop. Additionally, an air system 114 can be included that provides air to individual jets 102 and 104 through an air conduit 116, to aerate the water flowing through the jet. The air system 116 can be pump driven to increase the pressure of the air entering the jet 102, or can be vacuum based with the venturis located within the jets 102 drawing air into the jets 102 and water flow stream.

Although the present invention has been described in considerable detail with reference to certain preferred configurations, other versions are possible. The gasket can extend less than fully around the hole or opening. The spa components can have many different shapes and sizes and can be mounted with gaskets in holes having different shapes and sizes. The invention can be used in many different types of hydrotherapy jets and other spa components and can be used in many systems beyond spa systems. Therefore, the spirit and scope of the appended claims should not be limited to their preferred versions described above.

We claim:

1. A gasket for providing a watertight seal between a hole and a body mounted within said hole, comprising:
a front extension at least partially covering a front surface around said hole;
a rear extension at least partially covering a back surface of said hole, said front and rear extensions connected by a base section;
said body having a front portion and a back portion, said front extension sandwiched between said front portion 10 and said front surface to provide a watertight seal at said front surface at least partially around said hole, and said rear extension sandwiched between said back portion and said back surface to provide a watertight seal at said back surface at least partially around said hole.

2. The gasket of claim 1, wherein said base section is adjacent to the inside surface of said hole, between said body and said inside surface.

3. The gasket of claim 1, having a substantially U-shaped cross-section.

4. The gasket of claim 3, wherein said base section comprises the base of said substantially U-shaped cross-section, and said front and rear extensions provide the legs of said substantially U-shaped cross-section.

5. The gasket of claim 1, wherein said front or rear extensions have sealing features.

6. The gasket of claim 1, wherein said sealing features comprise ridges.

7. The gasket of claim 1, made of a material from the group consisting of rubber, plastic, silicone, and material made from a combination thereof.

8. The gasket of claim 1, made at least partially of a flexible material, with the remainder of the gasket made of a ridged material.

9. The gasket of claim 1, having a shape to substantially match the shape of said hole.

10. The gasket of claim 2, made of a compressible material, said base section providing a watertight seal between said inside surface of said hole and said body when said body is mounted within said hole.

11. The gasket of claim 2, wherein said base section bulges when said front extension and rear extension are sandwiched between said body front and back portion, respectively.

12. A gasket for providing a watertight seal between a spa wall hole and spa component, comprising:
a front extension at least partially covering the front surface of said spa wall hole;
a rear extension at least partially covering the back surface of said spa wall hole;
said spa component having a front portion and a back portion, said front extension sandwiched between said front portion and said front surface to provide a watertight seal at said front surface at least partially around said hole, and said rear extension sandwiched between said back portion and the back surface of said hole to provide a watertight seal at said back surface at least partially around said hole.

13. The gasket of claim 12, wherein said front and rear extensions are connected by a base section.

14. The gasket of claim 12, wherein said base section is adjacent to the inside surface of said hole, between said body and said inside surface.

15. The gasket of claim 12, having a substantially U-shaped cross-section.

16. The gasket of claim 12, wherein said front or rear extensions have ridges.

17. The gasket of claim 12, wherein said spa component front section comprises a front flange.

18. The gasket of claim 12, wherein said back portion comprises a wall fitting.

19. The gasket of claim 12, made of a compressible material, said base section providing a watertight seal between the inside surface of said hole and said spa component when said component is mounted within said hole.

20. The gasket of claim 12, wherein said base section bulges when said front extension and rear extension are sandwiched between said body front and back portion, respectively.

21. A spa system, comprising:
a spa shell that is capable of holding water;
at least one spa component mounted in a hole in said spa shell with a gasket, wherein said gasket comprises:
a front extension at least partially covering the front surface of said spa shell around spa shell hole;
a rear extension at least partially covering the back surface of said spa shell around said spa shell hole, said front and rear extensions connected by a base section;
said spa component having a front portion and a back portion, said front extension sandwiched between said front portion and said front surface of said spa shell around said hole to provide a watertight seal at said front surface at least partially around said hole, and said rear extension sandwiched between said back portion and the back surface of said spa shell around said hole to provide a watertight seal at said back surface at least partially around said hole.
